(19) United States
(12) Patent Application Publication
(10) Pub. No.: US 2016/0335500 A1
(43) Pub. Date: Nov. 17, 2016

(54) METHOD OF AND SYSTEM FOR GENERATING METADATA

(71) Applicant: YANDEX EUROPE AG, Luzern (CH)

(72) Inventors: Lidia Vladimirovna POPELO, Moscow (RU); Dmitry Vladimirovich CHUPROV, Odintsovo, Moscow Region (RU)

(21) Appl. No.: 15/106,328

(22) PCT Filed: Aug. 19, 2014
(86) PCT No.: PCT/IB14/63970

§ 371 Date: Jun. 20, 2016

(30) Foreign Application Priority Data
Feb. 14, 2014 (RU) 2014106042

(51) Int. Cl. G06K 9/00; G10L 25/51

(52) U.S. Cl. CPC G06K 9/00765; G10L 25/51; G06K 2209/03; G06K 2209/27; G06K 2209/01

(57) ABSTRACT

Method of and system for generating image metadata, comprising, at an electronic device: receiving an indication of text to be included in an image, the text comprising at least one character, each character being encoded according to a character encoding; generating the image based at least in part on the text, the image including an image representation of the text; generating the image metadata based at least in part on the text; and associating the image metadata with the image. Method of and system for generating video metadata. Method of and system for generating audio metadata.

### CROSS-REFERENCE

The present application claims convention priority to Russian Patent Application No. 2014106042, filed Feb. 14, 2014, entitled “METHOD OF AND SYSTEM FOR GENERATING METADATA” which is incorporated by reference herein in its entirety.

### FIELD

The present technology relates to methods and systems for generating metadata in respect of images, videos, and/or audio clips.

### BACKGROUND

Digital content creation has become increasingly affordable, accessible, and popular in recent years, as digital cameras, scanners, and graphics software have become commonplace. As a result, the number of digital content files created has increased, and so too has the need for techniques to organize, index, and search through digital content collections, such as collections of images, videos, or audio clips.

The ability to associate various metadata with images, videos, and audio clips is essential in this regard. For example, image metadata may include a title, a description, image size, camera settings, authorship and/or copyright information, creation and/or editing date and time, a thumbnail version of the image, and one or more descriptive keywords (sometimes called “tags”). Because these metadata are generally stored as computer-readable text, it is a simple matter for computers to index and/or search through the information they contain, thus enabling digital content with particular features described in the metadata to be quickly and efficiently identified from among many items in a large collection.

Some digital images include an image representation of text. For example, a photograph of a movie theatre may include a movie title (e.g. “Casablanca”) displayed on the theatre's marquee. While such text is often easily identifiable by a human observer, a computer may only identify an image representation of text as being text per se by performing an analysis of the image representation of the text, known as optical character recognition (OCR). An OCR algorithm analyzes images to detect visual patterns representative of text characters and then outputs those text characters in a definite, machine-encoded form known as a character encoding, normally a standard character encoding such as ANSI, ASCII or Unicode. The resulting text may then be unambiguously interpreted and manipulated by computer systems.

Online service Evernote™ uses OCR technology to identify text in an image uploaded by a user and associates metadata including the identified text with the image. The metadata associated with the image may then be indexed and/or searched, thus allowing the user (or another user) to find the image via a text-based search query including elements of the text as search terms. With reference to the aforementioned example, the photograph of the movie theatre may be uploaded to Evernote™, which may identify the movie title “Casablanca” in the image using OCR and consequently include the text string “Casablanca” in the image's metadata. A subsequent search for “Casablanca” may yield the image as a search result.

### SUMMARY

Inventors have developed embodiments of the present technology based on their appreciation of at least one shortcoming of the prior art. Notably, although generating image metadata using OCR in the manner of Evernote™ as described above may be effective in some cases, in other cases it is inconvenient due to the computational intensity and potential inaccuracy of OCR.

The present technology arises from the inventors' recognition that in some cases, image metadata associated with an image may be automatically generated as part of the process of generating and/or modifying that image. More specifically, when an image is generated or modified so as to include an image representation of known text, there is an opportunity to efficiently and reliably generate metadata based on that text, rather than later performing OCR to imperfectly recover the text from its image representation in the generated image.

Thus, in one aspect, implementations of the present technology provide a method of generating image metadata, the method comprising, at an electronic device:
receiving an indication of text to be included in an image, the text comprising at least one character, each character being encoded according to a character encoding;
generating the image based at least in part on the text, the image including an image representation of the text;
generating the image metadata based at least in part on the text; and
associating the image metadata with the image.

In some implementations, the image to be generated is not an entirely new image, but a previously existing image modified to include an image representation of the text. Thus, in some implementations, receiving the indication of the text to be included in the image comprises receiving an indication of text with which to modify an unmodified image, and generating the image based at least in part on the text comprises generating the image based at least in part on the text and the unmodified image. Any metadata associated with the previously existing image may be preserved, updated, or otherwise processed when generating the image metadata in respect of the generated image. Thus, in some further implementations, generating the image metadata based at least in part on the text comprises generating the image metadata based at least in part on the text and existing image metadata associated with the unmodified image.

In some such implementations, a screenshot of the electronic device's display may first be taken before being modified with the text to generate the image. For example, a user of a smartphone may take a screenshot while playing a game of Tetris™ and then provide text to be overlaid on the image. Thus, in some implementations, the unmodified image comprises a screenshot image of a display of the electronic device, and the method further comprises, before generating the image: receiving an instruction to generate the screenshot image from a user of the electronic device; and generating the screenshot image as the unmodified image. In other implementations, the screenshot image is that of a display of a device other than the electronic device. Thus, in some implementations, the unmodified image comprises a screenshot image of a display of a second electronic device in communication with the electronic device via a communications network; and further comprising, before generating the image, receiving the screenshot image from the second digital electronic device via the communications network.

In other implementations, a digital photograph may first be taken before being modified with the text to generate the image. In such implementations, the unmodified image comprises a digital photograph, and the method further comprises, before generating the image: receiving an instruction to capture the digital photograph from a user of the electronic device; and capturing the digital photograph via a camera coupled to the electronic device as the unmodified image.

In some implementations, in response to a user instructing the device to take a screenshot of a display of the electronic device, some or all of the text displayed on the display may be captured as the text to be used in the generation of the image. Thus, in some implementations, receiving the indication of the text to be included in the image comprises: receiving an instruction to generate a screenshot image of a display of the electronic device from a user of the electronic device; and capturing as the text at least some of the text displayed on the display. For example, this may be accomplished by requesting the displayed text from the one or more applications causing the text to be displayed on the display. An image including an image representation of the captured text may then be generated along with image metadata based on the captured text to be associated with the image. In some implementations, the image generated may actually be a screenshot of the display. In such implementations, generating the image based at least in part on the text comprises generating the screenshot image as the image. Thus, some implementations of the present technology allow for generation of screenshot images and association of metadata including text displayed in the screenshot images with those images, without having to perform OCR on the screenshot images. In other implementations, the image generated is not a screenshot image, though it includes an image representation of text that was displayed on the display when the instruction to take the screenshot was received. Thus, in other implementations, generating the image based at least in part on the text is generating the image based at least in part on the text without generating the screenshot image.

In another aspect, various implementations of the present technology provide a method of generating image metadata, the method comprising, at an electronic device:
receiving an indication of text with which to modify an image, the text comprising at least one character, each character being encoded according to a character encoding;
modifying the image based at least in part on the text to include an image representation of the text;
generating the image metadata based at least in part on the text; and
associating the image metadata with the image.

In another aspect, various implementations of the present technology provide a method of augmenting image metadata associated with an image, the method comprising, at an electronic device:
receiving an indication of text with which to modify the image, the text comprising at least one character, each character being encoded according to a character encoding;
modifying the image based at least in part on the text to include an image representation of the text;
generating additional image metadata based at least in part on the text; and
associating the additional image metadata with the image by adding the additional image metadata to the image metadata associated with the image.

The image and the image metadata may be associated in a variety of ways. Some image file types (e.g. JPEG, TIFF, PNG, and others) allow metadata to be stored in the file along with the image content. Thus, in some implementations, associating the image metadata with the image comprises writing an image file including the image and the image metadata to a non-transitory computer-readable medium. In other implementations, image metadata associated with the image may be stored separately from the digital image file, and an association between the two may be maintained in a database. Thus, in other implementations, associating the image metadata with the image comprises at least one of creating and modifying an entry in a database, the entry including an indication of the image and an indication of the image metadata. In still other implementations, the image and the image metadata may be associated by virtue of being referenced in a same communication, whether a low-level communication such as a single TCP or UDP packet, or a higher level communication such as an email or a transmission of an HTML or XML document. In such implementations, associating the image metadata with the image includes sending a communication including an indication of the image and an indication of the image metadata via a communications network.

In another aspect, various implementations of the present technology provide a method of generating video metadata, the method comprising, at an electronic device:
receiving an indication of text to be included in at least one frame of a video, the text comprising at least one character, each character being encoded according to a character encoding;
generating the video comprising the at least one frame based at least in part on the text, the at least one frame including an image representation of the text;
generating the video metadata based at least in part on the text; and
associating the video metadata with the video.

The video and the video metadata may be associated in a variety of ways. Some video file types (e.g. various types compliant with the MPEG-7 standard) allow metadata to be stored in the file along with the video content. Thus, in some implementations, associating the video metadata with the video comprises writing a video file including the video and the video metadata to a non-transitory computer-readable medium. In other implementations, video metadata associated with the video may be stored separately from the video file, and an association between the two may be maintained in a database. Thus, in other implementations, associating the video metadata with the video comprises at least one of creating and modifying an entry in a database, the entry including an indication of the video and an indication of the video metadata. In still other implementations, the video and the video metadata may be associated by virtue of being referenced in a same communication, whether a low-level communication such as a single TCP or UDP packet, or a higher level communication such as an email or a transmission of an HTML or XML document. In such implementations, associating the video metadata with the video includes sending a communication including an indication of the video and an indication of the video metadata via a communications network.

In another aspect, various implementations of the present technology provide a method of generating audio metadata, the method comprising, at an electronic device:
receiving an indication of text to be included in an audio clip, the text comprising at least one character, each character being encoded according to a character encoding;
generating the audio clip based at least in part on the text, the audio clip including an audio representation of the text;
generating the audio metadata based at least in part on the text; and
associating the audio metadata with the audio clip.

The audio clip and the audio metadata may be associated in a variety of ways. Some audio file types (e.g. various types compliant with AES metadata standards, MP3 files with ID3 tags) allow metadata to be stored in the file along with the audio clip. Thus, in some implementations, associating the audio metadata with the audio clip comprises writing an audio file including the audio clip and the audio metadata to a non-transitory computer-readable medium. In other implementations, audio metadata associated with the audio clip may be stored separately from the audio file, and an association between the two may be maintained in a database. Thus, in other implementations, associating the audio metadata with the audio clip comprises at least one of creating and modifying an entry in a database, the entry including an indication of the audio clip and an indication of the audio metadata. In still other implementations, the audio clip and the audio metadata may be associated by virtue of being referenced in a same communication, whether a low-level communication such as a single TCP or UDP packet, or a higher level communication such as an email or a transmission of an HTML or XML document. In such implementations, associating the audio metadata with the audio clip includes sending a communication including an indication of the audio clip and an indication of the audio metadata via a communications network.

In various implementations of above aspects, the metadata generated may include any number of fields. In some implementations, the metadata includes a text field, and generating the metadata includes populating the text field with at least some of the text. In some cases, the character encoding of the text may differ from that to be used in the metadata, requiring translation of the text from one encoding to the other. For example, the text may be encoded according to the ASCII standard and the image metadata may be encoded according to the Unicode standard. Thus, in some implementations, the character encoding is a first character encoding, the text field conforms to a second character encoding other than the first character encoding, and populating the text field with at least some of the text comprises translating the at least some of the text from the first character encoding to the second character encoding.

In various implementations of above aspects, the indication of the text is received after a user inputs the text using a keyboard, touchscreen, or other tactile device. A user may also input text using a microphone coupled to a voice recognition component implemented in hardware, software, or a combination of hardware and software. Thus, in some implementations, receiving the indication of the text comprises receiving the indication of the text from a user of the electronic device via the electronic device. As non-limiting examples, the user may type text using a physical keyboard or a virtual keyboard (perhaps displayed on a touchscreen), or speak text into a microphone to be interpreted by a voice recognition component. Thus, in some such implementations, receiving the indication of the text from the user of the electronic device comprises receiving the indication of the text via at least one of a physical keyboard of the electronic device, a virtual keyboard of the electronic device, and a voice recognition component coupled to a microphone of the electronic device. The physical keyboard, virtual keyboard, and/or microphone of the electronic device may (but need not) be part of the electronic device itself, so long as they are coupled to the electronic device—e.g. via a wired or wireless direct link or communications network—so as to be able to relay information to the electronic device based on inputs they receive from the user.

In other various implementations of above aspects, the text may be remotely communicated to the electronic device from another device via a direct link or via a communications network. Thus, in some implementations, receiving the indication of the text comprises receiving the indication of the text from a second electronic device in communication with the electronic device via at least one of a direct link and a communications network. Any suitable direct link or communications network may be used, whether wired, wireless, or a combination of wired and wireless. Suitable examples include universal serial bus (USB) cables, Ethernet cables, TOSLINK fiber optic cables, coaxial cables, IrDA wireless links, Bluetooth™ wireless links, Wi-Fi Direct™ wireless links, local area networks, cellular networks, and the Internet, though any other means of communicating an indication of text may be employed.

In more general terms, the present technology allows for metadata to be generated and associated with digital content in whatever form it may take (including images, videos, audio, and other forms) as part of the process of generating and/or modifying that content to include a non-textual representation of text—that is, a representation of the text in the medium of the digital content itself. Thus, in one aspect, various implementations of the present technology provide a method of generating metadata, the method comprising, at an electronic device:
receiving an indication of text to be represented in digital content, the text comprising at least one character, each character being encoded according to a character encoding;
generating the digital content based at least in part on the text, the digital content including a non-textual representation of the text in at least a portion of the digital content;
generating the metadata based at least in part on the text; and
associating the metadata with the digital content.

As described above, various approaches of associating the metadata with the digital content may be taken, such as storing them in a same file, including a reference to one in the other, including a reference to both in a same file or database entry, sending a communication including an indication of the metadata and an indication of the digital content via a communications network, or any other suitable means.

In other aspects, various implementations of the present technology provide an electronic device suitable for carrying out above-described methods.

In the context of the present specification, an “electronic device” is any hardware and/or software appropriate to the relevant task at hand. Thus, some (non-limiting) examples of electronic devices include computers (servers, desktops, laptops, netbooks, etc.), smartphones, and tablets, as well as network equipment such as routers, switches, and gateways.

In the context of the present specification, a “display” of an electronic device is any electronic component capable of displaying an image to a user of the electronic device. Non-limiting examples include cathode ray tubes, liquid crystal displays, plasma televisions, projectors, and head-mounted displays such as Google Glass™.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “indication of” is meant to refer to any type and quantity of information enabling identification of the object which it qualifies, whether or not that information includes the object itself. For instance, an “indication of text” refers to information enabling identification of the text in question, whether or not that information includes the text itself. Non-limiting examples of indications that do not include the object itself include hyperlinks, references, and pointers.

In the context of the present specification, a character may be said to be “encoded according to a character encoding” if it may be unambiguously interpreted by appropriately programmed computer hardware and/or software as representative of that character with reference to that character encoding. The present technology is not limited to any particular character encoding, nor is it limited to standard character encodings such as ASCII or Unicode (e.g. UTF-8), as proprietary character encodings may also be used. As a counterexample, an image representation of a character is not a “character encoded according to a character encoding” because the image representation may be interpreted to represent one of two (or more) characters, depending on particularities of the OCR algorithm employed to detect the character represented by the image representation.

In the context of the present specification, “image metadata” is meant to refer to any type and quantity of information about at least one image, structured either according to a known standard or according to a proprietary structure, whether the one or more elements of that metadata are located together with the image, separately from the image, or a combination thereof.

In the context of the present specification, “video metadata” is meant to refer to any type and quantity of information about at least one video, structured either according to a known standard or according to a proprietary structure, whether the one or more elements of that metadata are located together with the video, separately from the video, or a combination thereof.

In the context of the present specification, “audio metadata” is meant to refer to any type and quantity of information about at least one audio clip, structured either according to a known standard or according to a proprietary structure, whether the one or more elements of that metadata are located together with the audio clip, separately from the audio clip, or a combination thereof.

In the context of the present specification, the expressions “unmodified image” and “modified image” are meant to refer only to an incremental modification of an image according to the present technology. An unmodified image may well have been modified previously, whether according to the present technology or not.

In the context of the present specification, a “screenshot image” of a display is meant to refer to an image substantially replicating the visual content displayed on the display at a given time (usually but not necessarily at the time generation of the screenshot image was requested).

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “component” is meant to refer either to hardware, software, or a combination of hardware and software that is both necessary and sufficient to achieve the specific function(s) being referenced. For example, a “voice recognition component” includes hardware and/or software suitable for translating a live or previously recorded audio sample of a human voice into a textual equivalent.

In the context of the present specification, the expression “computer-readable medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a context diagram of a networked computing environment suitable for use with implementations of the present technology described herein;

FIG. 2 is an example of a screenshot image of a display of an electronic device;

FIG. 3 is an example of a user interaction of a user with a touchscreen display displaying the image of FIG. 2, wherein the user taps a portion of the screenshot image;

FIG. 4 shows a continuation of the user interaction of FIG. 3, wherein a cursor and virtual keyboard are displayed to invite the user to add text to the image;

FIG. 5 shows a further continuation of the user interaction, wherein the user has partially entered text via the virtual keyboard;

FIG. 6 shows a modified image resulting from the completion of the user interaction, wherein text has been added to the image of FIG. 2;

FIG. 7 shows a block diagram representing an image file according to the Portable Network Graphics (PNG) specification.

FIG. 8-22 show flowcharts of various embodiments of methods for generating metadata according to various implementations of the present technology.

### DETAILED DESCRIPTION

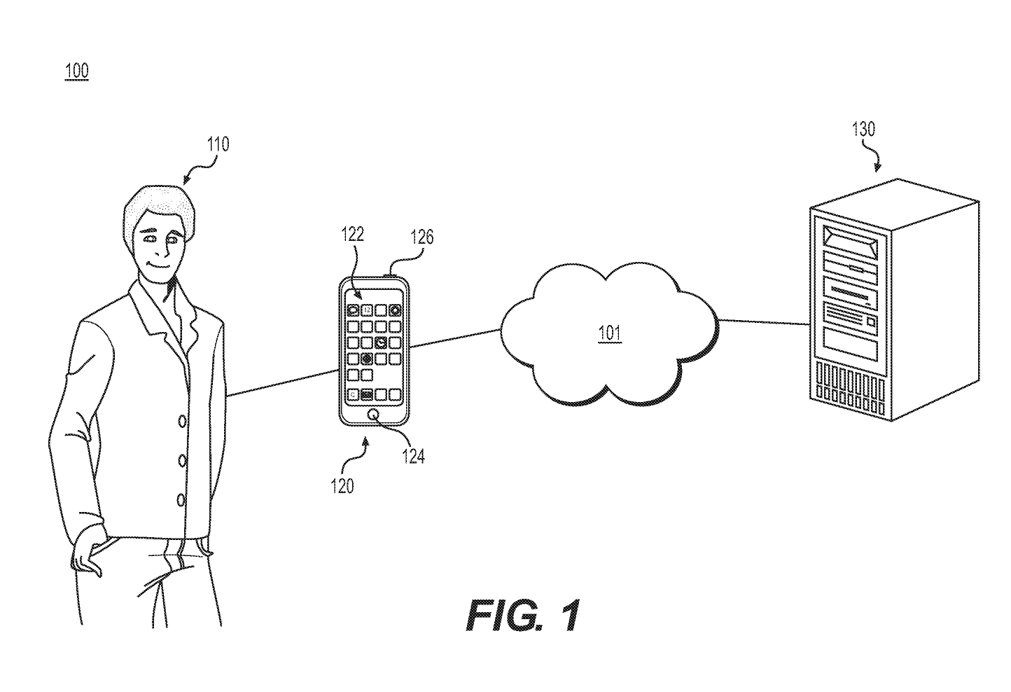

Referring to FIG. 1, there is shown a diagram of a simple networked computing environment 100 comprising a smartphone 120 in communication with a server 130 via a communications network 101 (e.g. the Internet). It is to be expressly understood that the various elements of networked computing environment 100 depicted herein and hereinafter described are merely intended to illustrate some possible implementations of the present technology. The description which follows is not intended to define the scope of the present technology, nor to set forth its bounds. In some cases, what are believed to be helpful examples of modifications to computer systems 100 may also be described below. This is done merely as an aid to understanding, and, again, not to define the scope or bounds of the present technology. These modifications are not an exhaustive list, and, as a person skilled in the art would understand, other modifications are likely possible. Further, where examples of modifications are absent, the mere absence of such examples should not be interpreted to mean that no modifications are possible and/or that what is described is the sole manner of implementing that element of the present technology. As a person skilled in the art would understand, this is likely not the case. It is also to be understood that elements of the networked computing environment 100 may represent relatively simple implementations of the present technology, and that where such is the case, they have been presented in this manner as an aid to understanding. As persons skilled in the art would understand, various implementations of the present technology may be of a greater complexity.

Smartphone 120 depicted in FIG. 1 is an Apple™ iPhone™ running the iOS™ operating system. In other implementations, another suitable operating system (e.g. Google Android™, Microsoft Windows Phone™, BlackBerry OS™) may be used. Moreover, because the present technology is not limited to mobile devices, smartphone 120 may be replaced by a non-mobile device in other implementations of the present technology. In the depicted implementation, smartphone 120 includes a touchscreen display 122, a home button 124, and a power button 126, and it is operated by user 110.

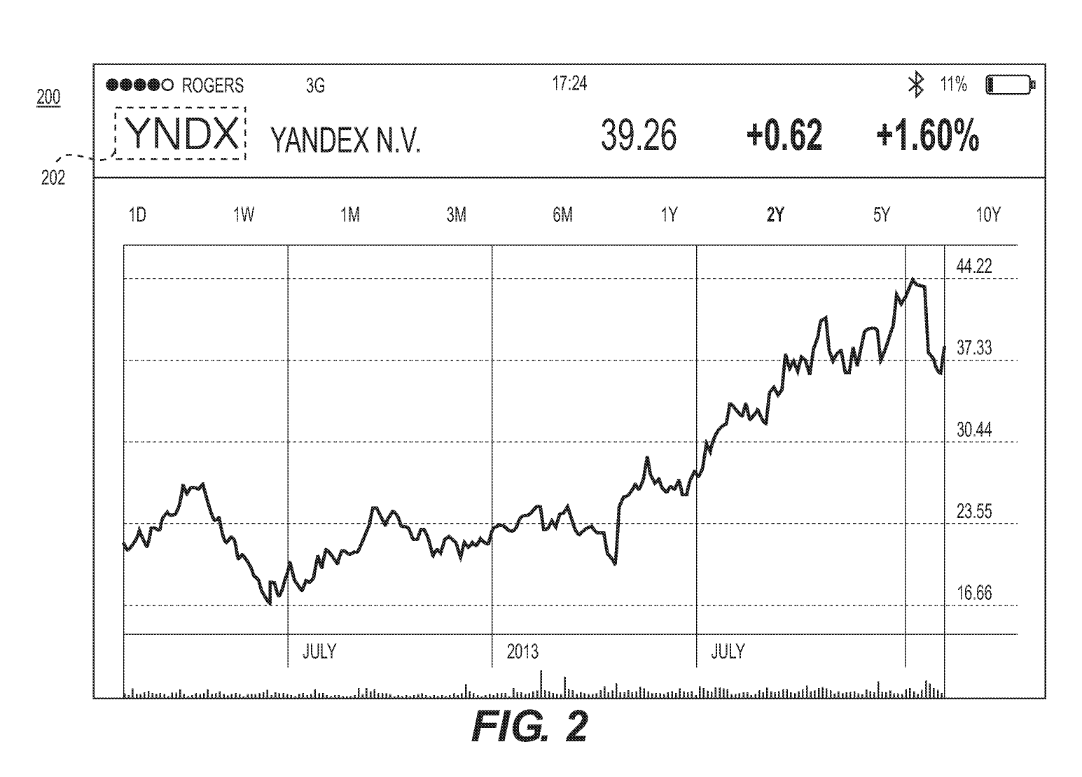

User 110 may operate smartphone 120 to launch an application which displays visual content on touchscreen display 122. For example, user 110 may launch the “Stocks” iOS application and then operate it to display a two-year chart of shares trading under the ticker YNDX on the NASDAQ stock exchange, as depicted in FIG. 2. User 110 may then provide an instruction to smartphone 120 to capture a screenshot image of the visual content displayed on display 122, for example by simultaneously pressing home button 124 and power button 126 of smartphone 120, causing smartphone 120 to generate a screenshot image such as the screenshot image 200 depicted in FIG. 2.

In some cases, the visual content displayed on display 122 when user 110 instructs smartphone 120 to capture the screenshot image may include known text (i.e. text susceptible of unambiguous interpretation by smartphone 120 based on a character encoding of the one or more characters included in that text). For example, with reference again to FIG. 2, when user 110 instructed smartphone 120 to capture screenshot image 200, the visual content being displayed by the “Stocks” app on display 122 of smartphone 120 included several known text elements, such as the text “YNDX” labeled 202. By querying the “Stocks” app to identify any text elements (e.g. “YNDX”) it is displaying on display 122 when the screenshot capture instruction is received, implementations of the present technology may obtain the text elements and subsequently use them when generating image metadata to be associated with the screenshot image. Note that the text 202 “YNDX” has been arbitrarily singled out from among the many text elements shown in FIG. 2 (e.g. “YANDEX N.V.”, “+0.62”, “JULY”, “2013”, “23.55”, “3M”, “ROGERS”, etc.), any of which could be substituted for text 202 in the following description.

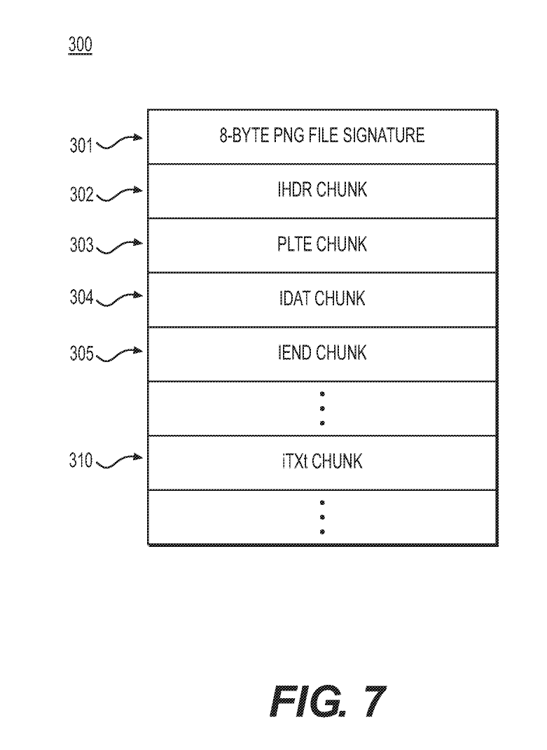

In some but not all implementations of the present technology, smartphone 120 takes advantage of the fact that text 202 is known unambiguously at the time screenshot image 200 is generated. More specifically, in such implementations, smartphone 120 generates image metadata based on text 202 either in parallel with or as part of the process of generating screenshot image 200, and then associates that image metadata with screenshot image 200. In some implementations, this may be as simple as copying text 202 (e.g. “YNDX”) into a text field of the image metadata, and then saving that image metadata together with the image in an image file (e.g. in the iTXt chunk of a PNG image file, as described in more detail below with reference to FIG. 7).

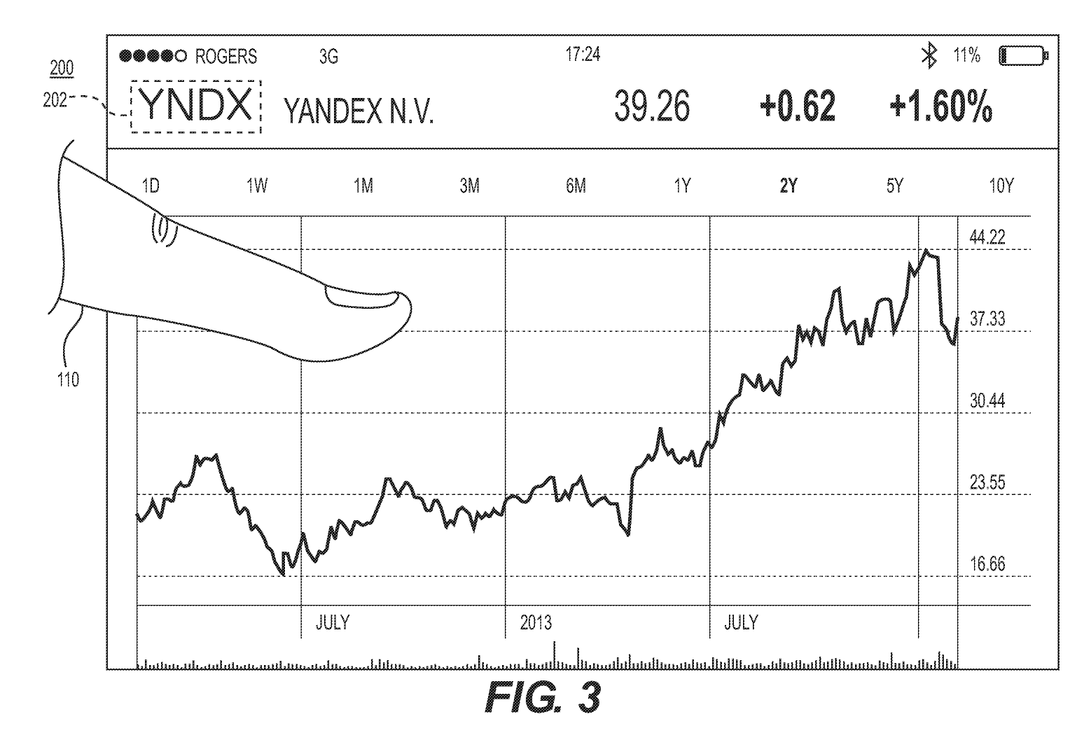

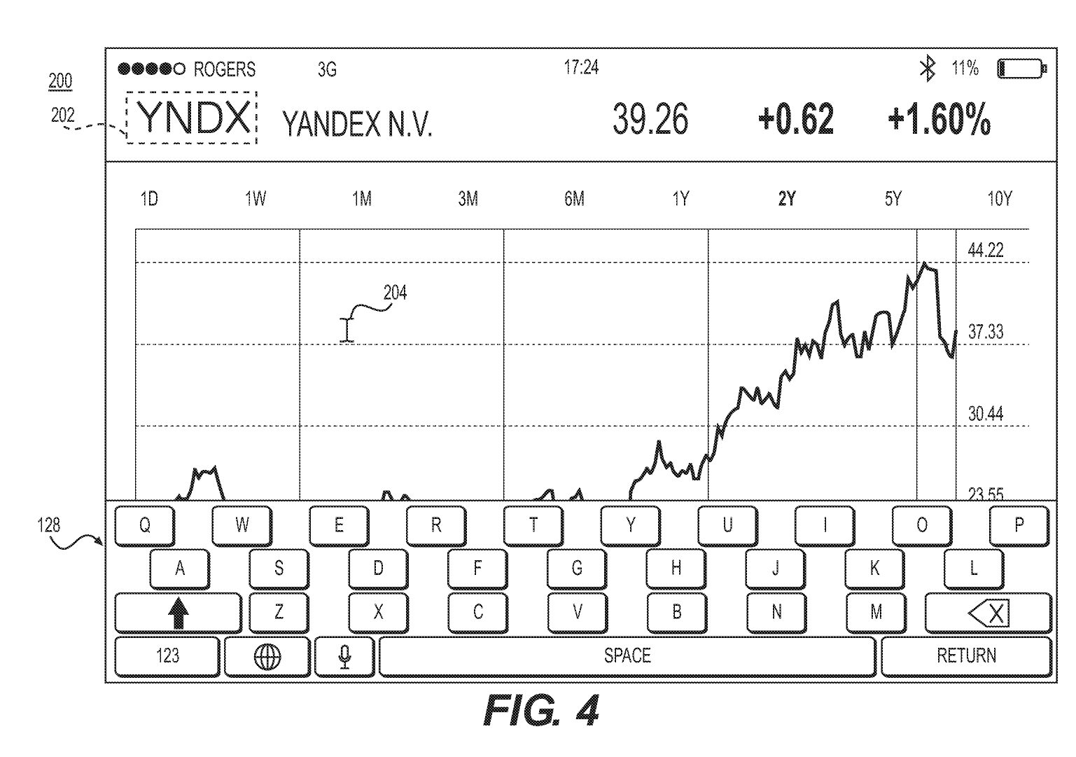

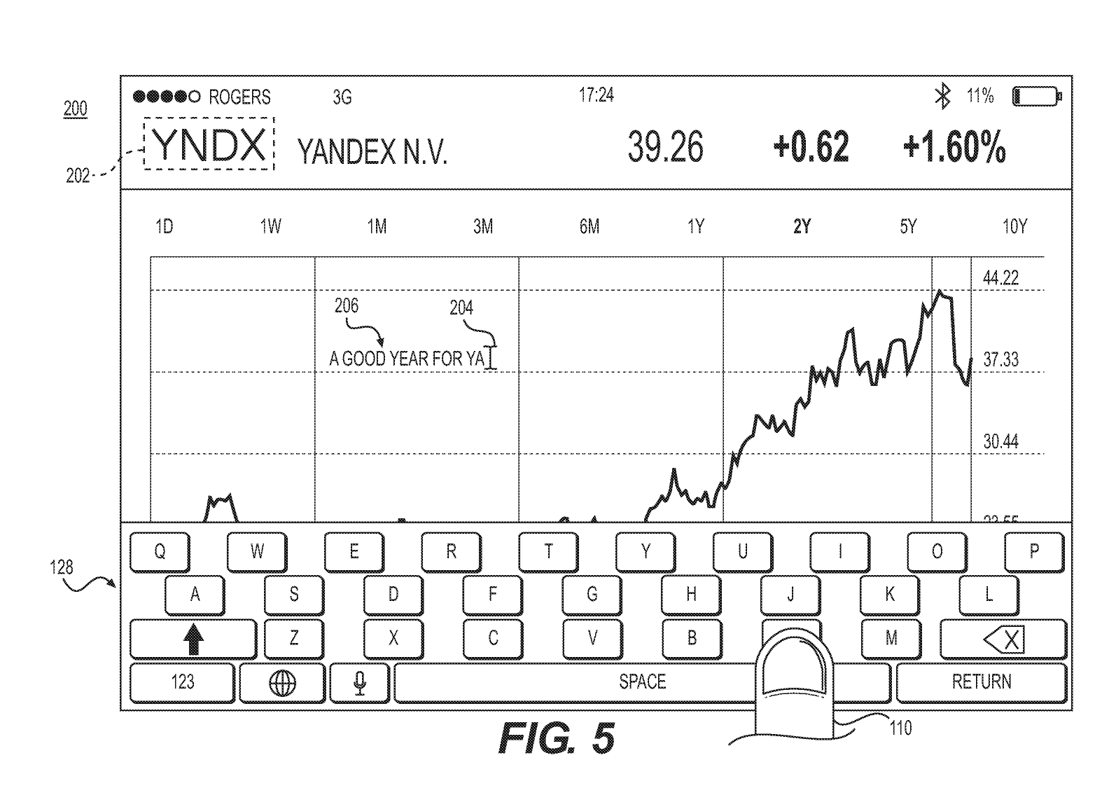

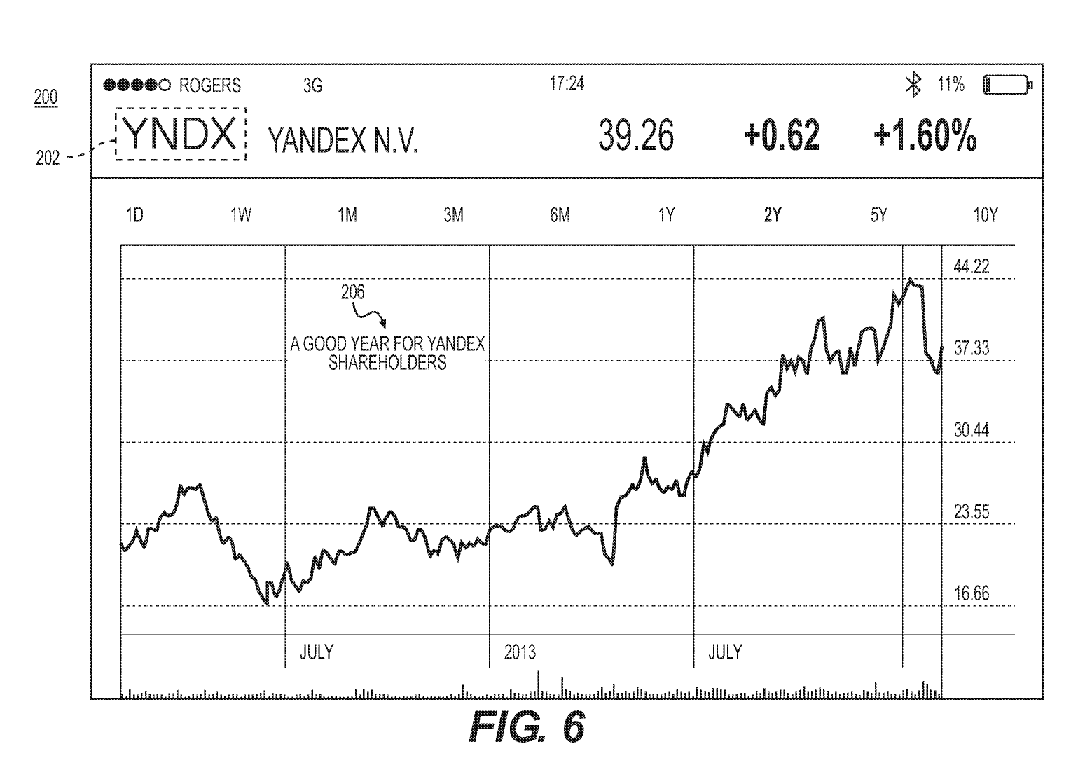

In some implementations, image metadata is generated while an unmodified image such as screenshot image 200 is modified by user 110 to include an image representation of text. An example user interaction resulting in such a modification is depicted in FIGS. 3 to 6. In FIG. 3, user 110 taps a portion of screenshot image 200. This causes smartphone 120 to display cursor 204 and virtual keyboard 128 on display 122 of smartphone 120 as depicted in FIG. 4. In FIG. 5, user 110 is in the process of entering the text “A GOOD YEAR FOR YANDEX SHAREHOLDERS” by tapping the virtual keys of virtual keyboard 128. In some implementations, individual keystrokes are received and processed one by one. In others, keystrokes are buffered until the user indicates the text 206 is complete (e.g. by tapping return or a portion of the screen other than virtual keyboard 128). Once text 206 has been completely entered, smartphone 120 generates the modified image shown in FIG. 6, which includes an image representation of text 206. Smartphone 120 also generates image metadata based at least in part on text 206. For example, the image metadata may comprise a text field, and smartphone 120 may populate the text field with one or more characters included in text 206, such as “SHARE” or “SHAREHOLDERS” or “GOOD YEAR”.

In some implementations, the functionality of generating metadata from known text while generating a screenshot image may be combined with the functionality of generating metadata while modifying that screenshot image. For example, first image metadata may be generated based on the text 202 “YNDX” while generating screenshot image 200 as an image to be modified (i.e. an “unmodified image”), second image metadata may be generated based on text 206 “A GOOD YEAR FOR YANDEX SHAREHOLDERS”, and both the first image metadata and the second image metadata may be associated with the resulting image (i.e. that shown in FIG. 6), which includes a respective image representation of each of text 202 and text 206.

One means of associating the generated image and the generated image metadata is by writing an image file including them both to a computer-readable storage medium, such as a memory of smartphone 120. For the sake of compatibility, a popular image file format such as the Portable Network Graphics (PNG) file format may be used. A variety of programming libraries for creating and manipulating PNG files exist, including libpng, which is available as source code in the C programming language. FIG. 7 shows a block diagram of a PNG image file 300. The first eight bytes of the file (labeled 301) consist of the standard PNG file signature. A series of critical “chunks” 302 to 305 then follows. The IHDR chunk 302 contains image 300's width, height, and bit depth. The PLTE chunk 303 contains the palette or list of colors used in image 300. One or more IDAT chunks 304 contain the actual image data of image 300. Finally, the IEND chunk 305 indicates the end of the image data. According to the PNG specification, a variety of ancillary chunks may be included in a PNG image file 300. One such chunk is the iTXt chunk 310, which allows for storage of text comprising characters encoded according to the UTF-8 character encoding. Some implementations of the present technology may associate a generated image with generated image metadata comprising a text field by including in a PNG image file 300 the image data of the image in one or more IDAT chunks 304 and the text field in an iTXt chunk 310. In some implementations, characters of the text will need to be converted to UTF-8 from a character encoding other than UTF-8, according to known techniques well known to those skilled in the art.

Apart from PNG files, many other image file formats are also suitable for storing image metadata along with an image. Non-limiting examples include JPEG and TIFF files, which support the EXIF (exchangeable image file format) standard commonly used in digital camera technology to store information about digital photographs.

Other means of associating the image and image metadata are also possible. One such means comprises creating or modifying one or more database entries to indicate that the image metadata pertains to the image. For example, this may be indicated merely by including, in the one or more database entries, both an indication of the image and an indication of the image metadata. Another means comprises storing each of the image and the image metadata in separate files, wherein at least one of the files includes an indication of the other file (e.g. an absolute or relative link/pointer/reference to the other file).

As those skilled in the art will understand, implementations of the present technology may likewise provide a method of generating metadata in respect of a video based on text to be included in one or more of the images that make up the individual frames (series of images) of the video. The video and metadata may each be generated based at least in part on the text and then associated with one another (e.g. via a video file including the video and the metadata, a database entry, a communication including the video and the metadata, or some other means of association). Similarly, implementations of the present technology may provide a method of generating metadata in respect of audio, wherein both audio which includes an audio representation of text (e.g. generated via text-to-speech technology) and metadata based at least in part on the text may be generated and associated with one another.

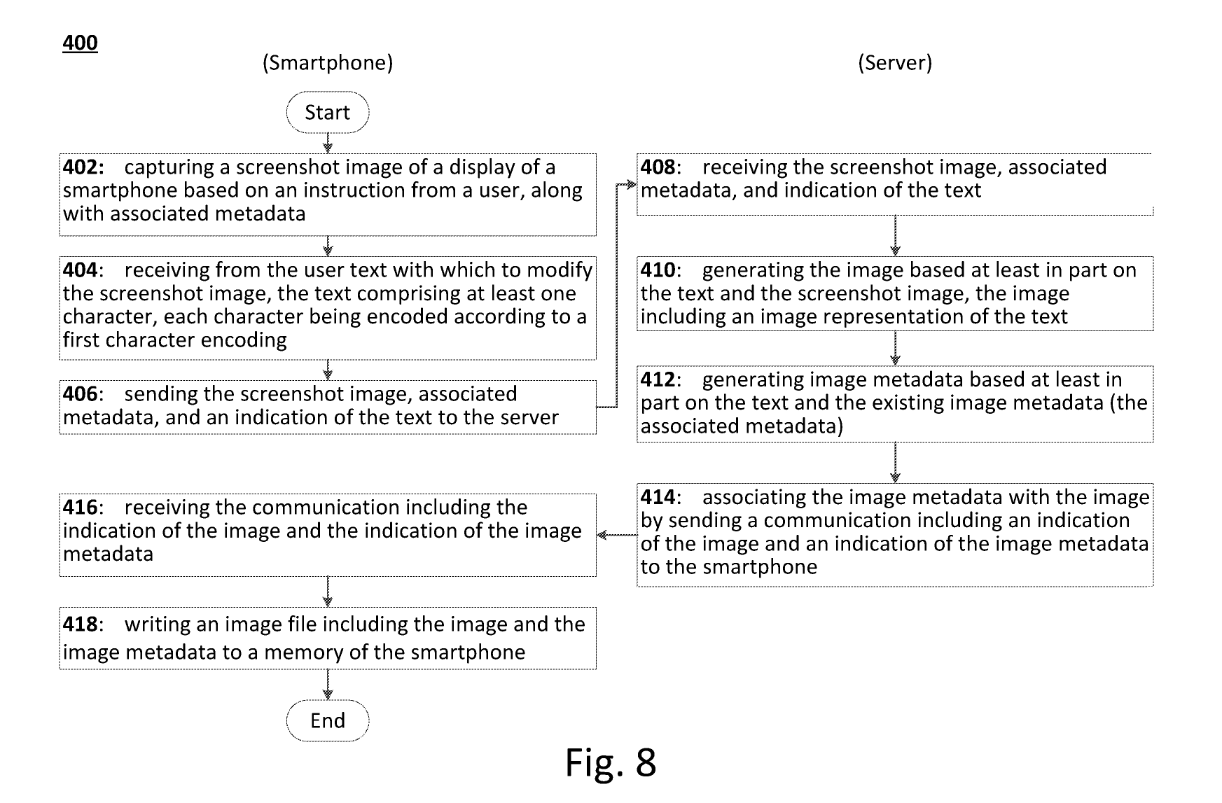

FIG. 8 shows a flowchart of a method 400 for generating image metadata according to an embodiment of a client-server implementation of the present technology, wherein a smartphone 120 acts as a client device in communication with a server 130 as depicted in FIG. 1. At step 402, smartphone 120 captures a screenshot of its display 122 based on an instruction from user 110. At step 404, user 110 inputs text with which to modify the screenshot image. At step 406, both the screenshot image and the text are sent by smartphone 120 to server 130 via communications network 101. At step 408, server 130 receives the screenshot image and the indication of the text. At step 410, server 130 generates the image based at least in part on the text and the screenshot image, the image including an image representation of the text. At step 412, server 130 generates image metadata based at least in part on the text and existing image metadata associated with the screenshot image. This includes populating a text field of the image metadata with at least some of the text, which in turn includes translating the text from a first character encoding to a second character encoding. At step 414, server 130 associates the generated image and image metadata by sending an indication of each to smartphone 120 in a communication. At step 416, smartphone 120 receives the indications, and finally, at step 418, smartphone 120 writes an image file including the image and the image metadata to a non-transitory computer-readable medium of smartphone 120.

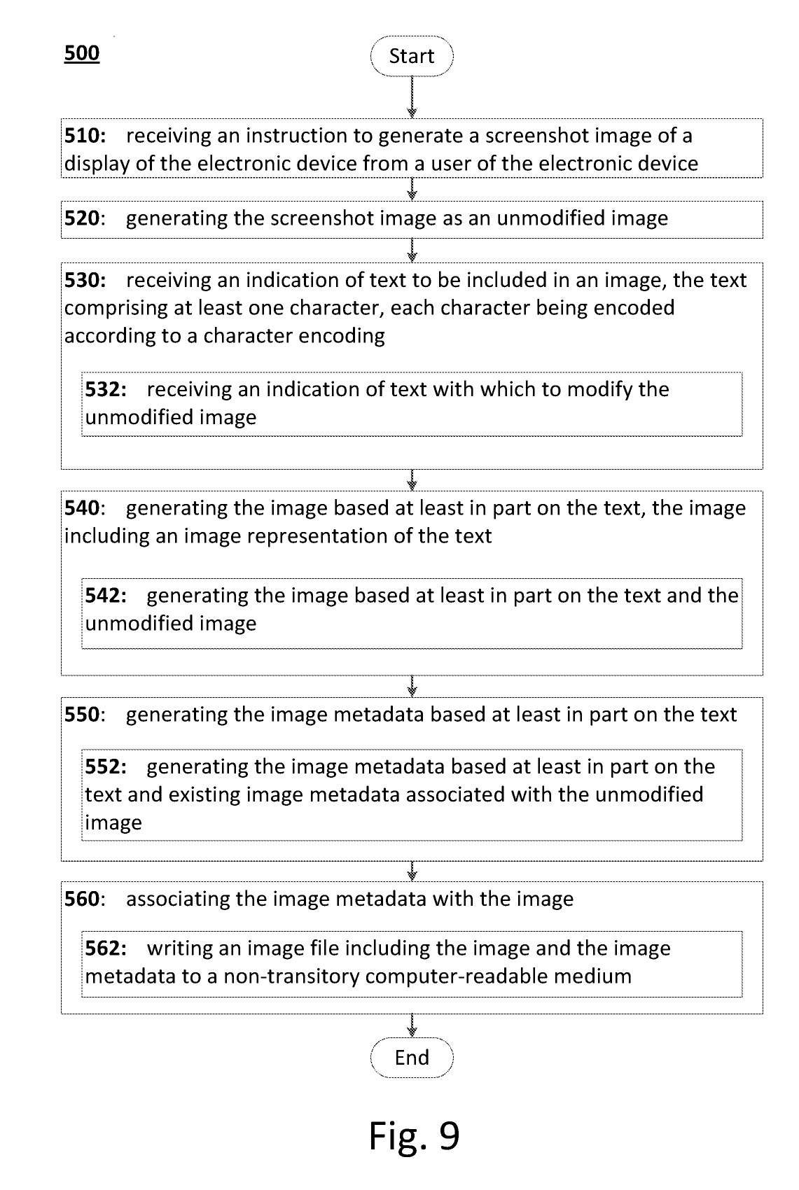

FIG. 9 shows a flowchart of a method 500 for generating image metadata while modifying a screenshot image according to implementations of the present technology. At step 510, an instruction to generate a screenshot image of a display of the electronic device is received from a user of the electronic device. At step 520, the screenshot image is generated as an unmodified image. At step 530, an indication of text to be included in an image is received. Step 530 comprises step 532. At step 532, an indication of text with which to modify the unmodified image is received. At steps 540/542, the image is generated based at least in part on the text and the unmodified image, the image including an image representation of the text. At steps 550/552, the image metadata is generated based at least in part on the text and existing image metadata associated with the unmodified image (the screenshot image). At step 560 the image metadata is associated with the image. Step 560 comprises step 562. At step 562, an image file is written to a non-transitory computer-readable medium.

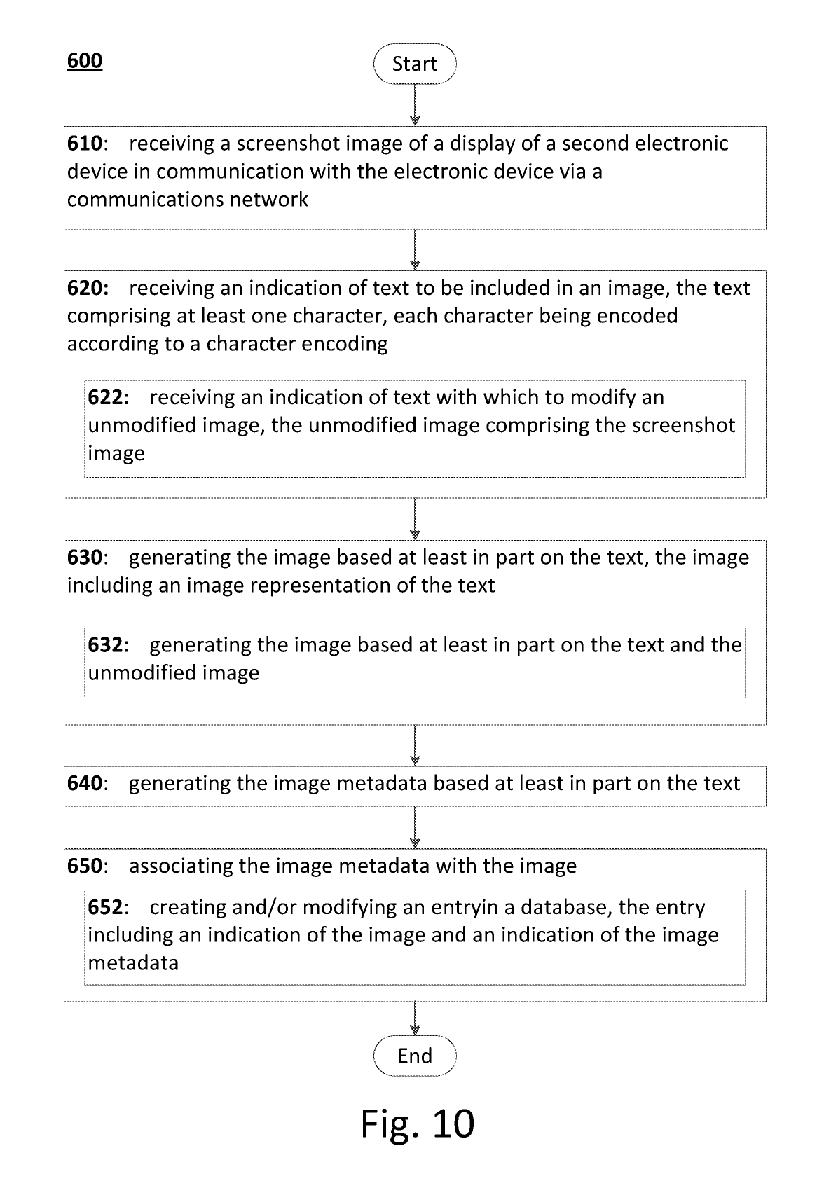

FIG. 10 shows a flowchart of a method 600 for generating image metadata while modifying a screenshot image according to implementations of the present technology. At step 610, a screenshot image is received from another electronic device via a communications network. At step 620, an indication of text to be included in an image is received. Step 620 comprises step 622. At step 622, an indication of text with which to modify an unmodified image comprising the screenshot image is received. At steps 630/632, the image is generated based at least in part on the text and the unmodified image, the image including an image representation of the text. At step 640, the image metadata is generated based at least in part on the text. At step 650, the image metadata is associated with the image. Step 650 comprises step 652. At step 652, an entry in a database is created and/or modified to include an indication of the image and an indication of the image metadata.

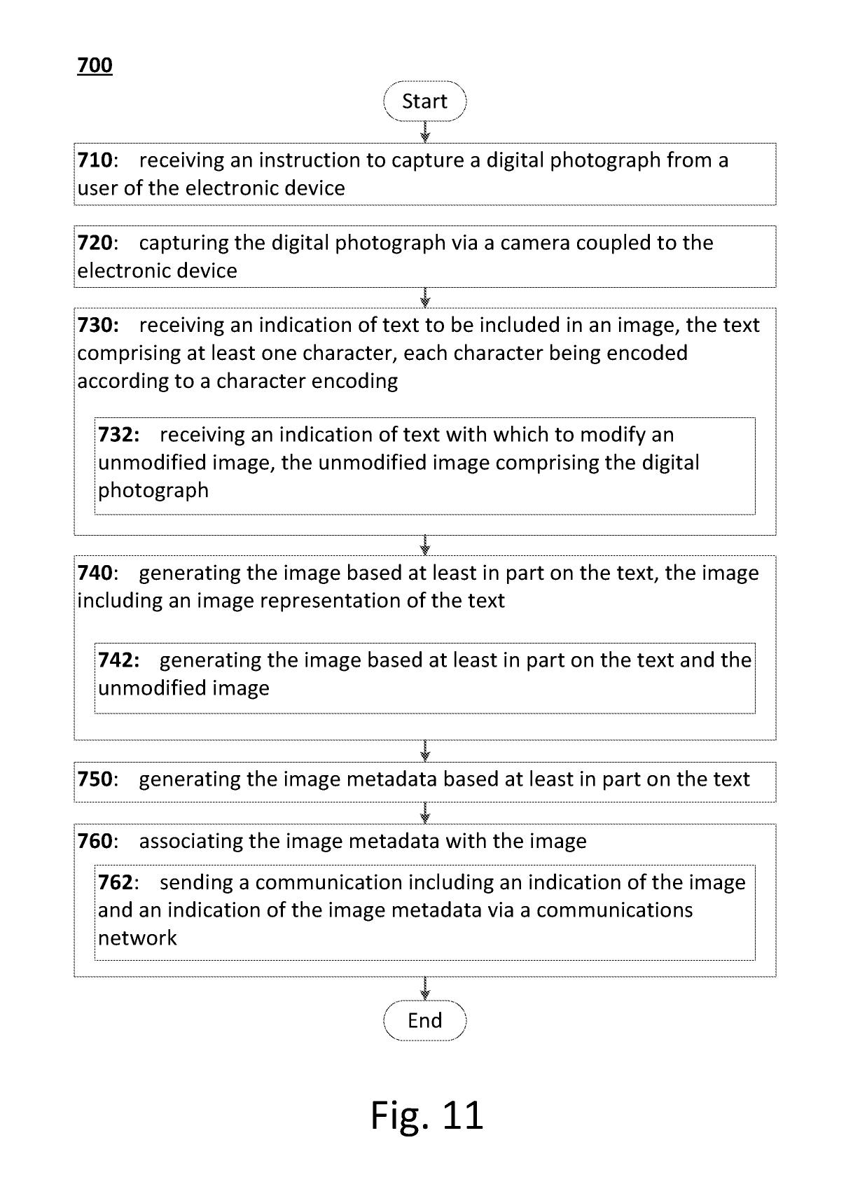

FIG. 11 shows a flowchart of a method 700 for generating image metadata while modifying a digital photograph according to implementations of the present technology. At step 710, an instruction to capture a digital photograph is received from a user of the electronic device. At step 720, the digital photograph is captured via a camera coupled to the electronic device. At step 730, an indication of text to be included in an image is received. Step 730 comprises step 732. At step 732, an indication of text with which to modify an unmodified image, the unmodified image comprising the digital photograph, is received. At steps 740/742, an image is generated based at least in part on the text and the unmodified image generating the image based at least in part on the text, the image including an image representation of the text. At step 750, image metadata is generated based at least in part on the text. At step 760, the image metadata is associated with the image. Step 760 includes step 762. At step 762, a communication including an indication of the image and an indication of the image metadata is sent via a communications network.

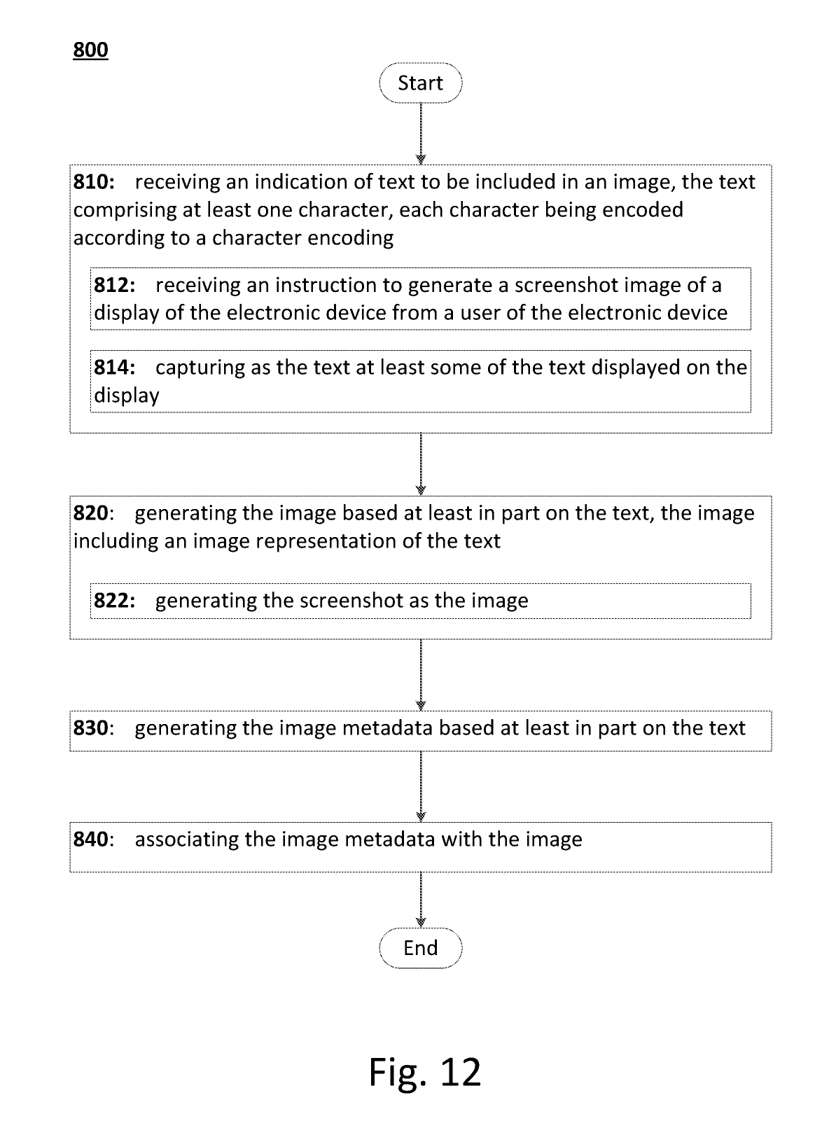

FIG. 12 shows a flowchart of a method 800 for generating screenshot image metadata based on text displayed on a display when a screenshot capture instruction is received. At step 810, an indication of text to be included in an image is received. Step 810 comprises steps 812 and 814. At step 812, an instruction to generate a screenshot image of a display of the electronic device is received from a user of the electronic device. At step 814, at least some of the text displayed on the display is captured as the text to be included in the image. At steps 820/822, the screenshot image is generated based at least in part on the text, the image including an image representation of the text. At step 830, the image metadata is generated based at least in part on the text. At step 840, the image metadata is associated with the image.

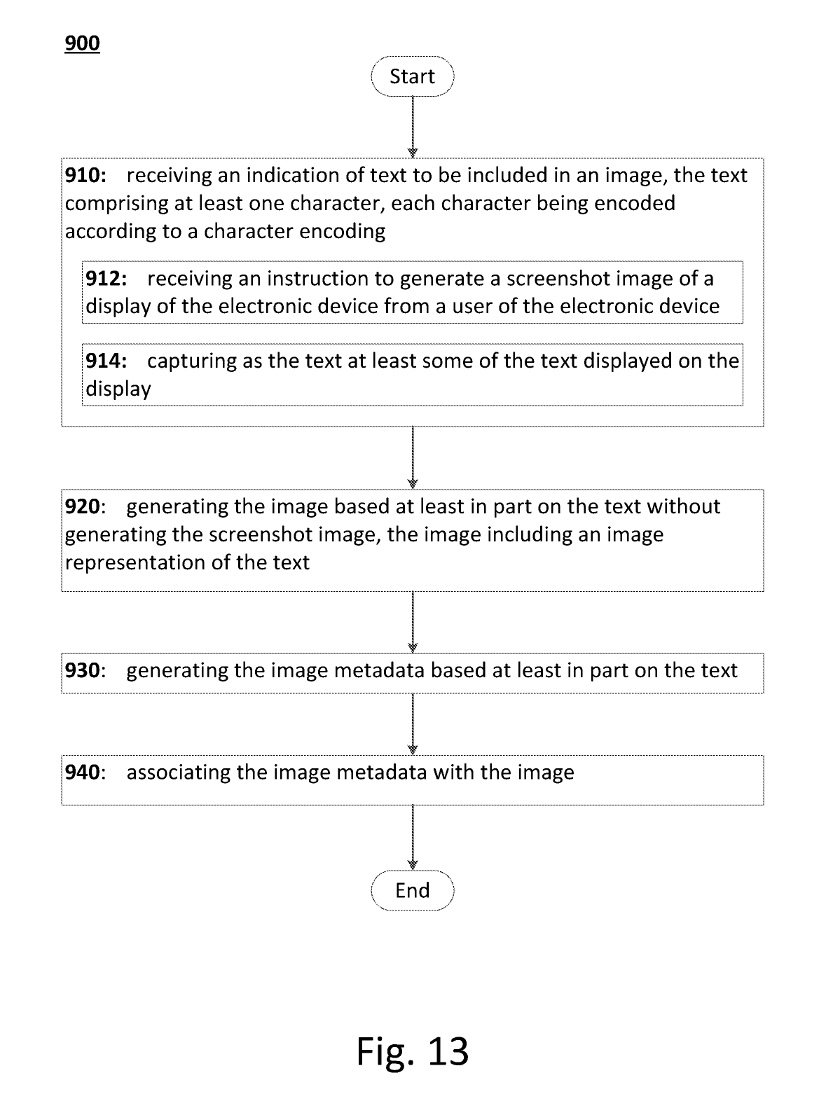

FIG. 13 shows a flowchart of a method 900 for generating image metadata in respect of an image other than a screenshot image when a screenshot capture instruction is received. Thus, instead of generating an actual screenshot, an image which includes at least some text displayed on the display is generated. For example, if the words “File” and “Home” are displayed on the display when the screenshot capture instruction is received, an image including an image representation of “File” may be generated, without necessarily including other text or graphics displayed on the display. At step 910, an indication of text to be included in the image is received. Step 910 comprises steps 912 and 914. At step 912, an instruction to generate a screenshot image of a display of the electronic device is received. At step 914, at least some of the text displayed on the display is captured (e.g. “File”) as the text to be included in the image. The text in question may be captured, for example, by sending a request to the application which is causing the text to be displayed to identify the text. At step 920 an image based at least in part on the text is generated, the image including an image representation of the text. At step 930, the image metadata is generated based at least in part on the text. At step 940, the image metadata is associated with the image.

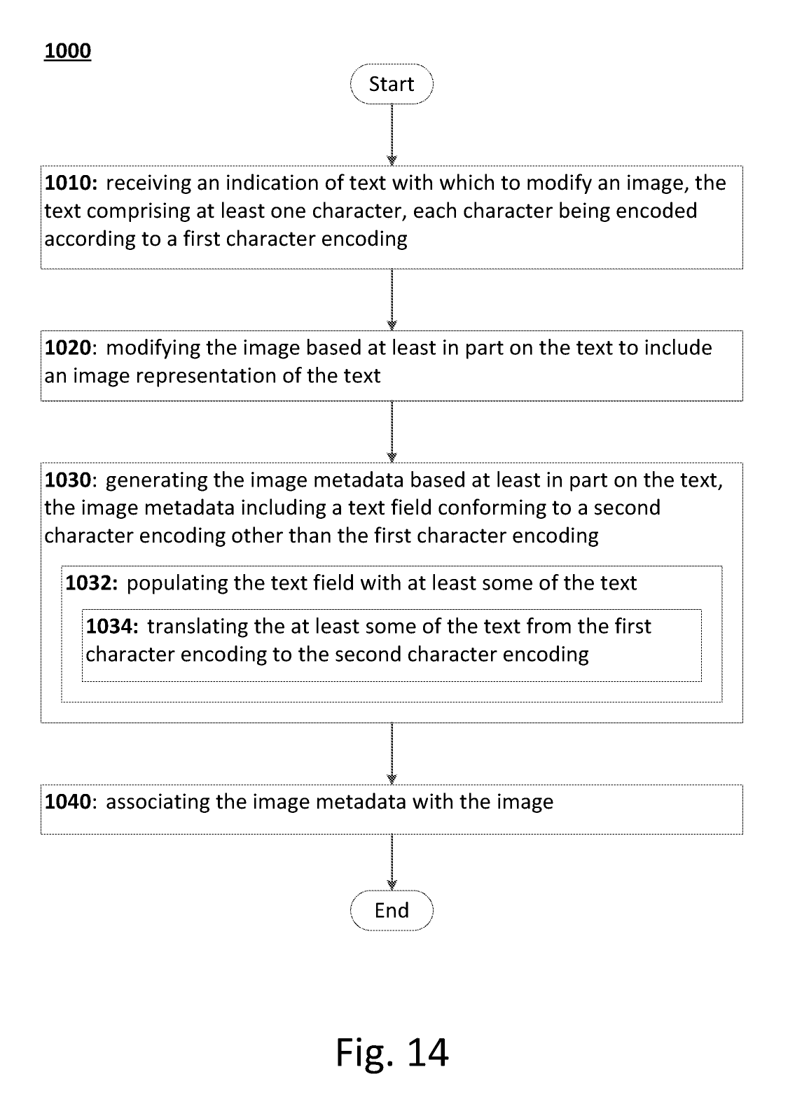

FIG. 14 shows a flowchart of a method 1000 for generating image metadata while modifying an image. At step 1010, an indication of text with which to modify an image is received, the text comprising at least one character, each character being encoded according to a first character encoding (e.g. ASCII). At step 1020, the image is modified based at least in part on the text to include an image representation of the text. At step 1030, the image metadata is generated based at least in part on the text, the image metadata including a text field conforming to a second character encoding (e.g. UTF-8) other than the first character encoding. Step 1030 comprises step 1032. At step 1032, the text field is populated with at least some of the text. Because the character encoding is different, step 1032 comprises step 1034, namely translating the at least some of the text from the first character encoding to the second character encoding. At step 1040, the image metadata is associated with the image.

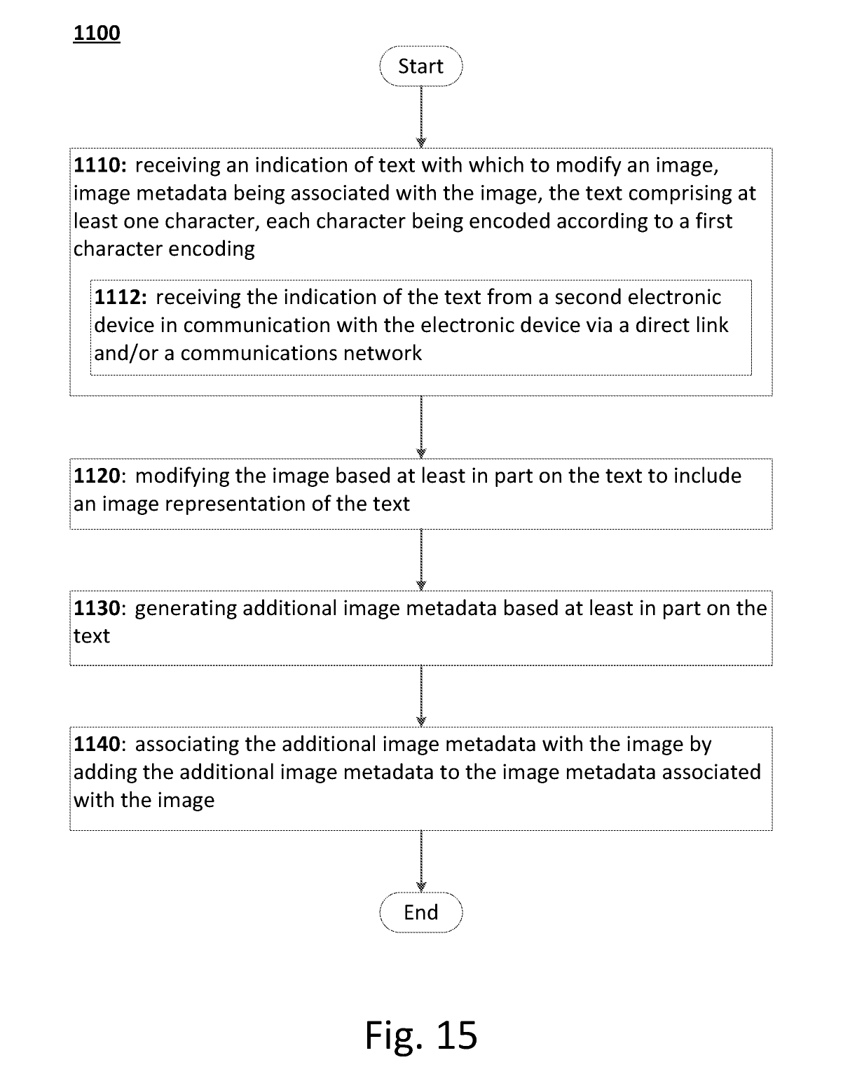

FIG. 15 shows a flowchart of a method 1100 for augmenting image metadata associated with an image when that image is modified. At step 1110, an indication of text with which to modify an image is received. Step 1110 comprises step 1112. At step 1112, the indication of the text is received from another electronic device in communication with the electronic device via a direct link and/or a communications network. At step 1120, the image is modified based at least in part on the text to include an image representation of the text. At step 1130, additional image metadata is generated based at least in part on the text. At step 1140, the additional image metadata is associated with the image by adding the additional image metadata to the image metadata associated with the image.

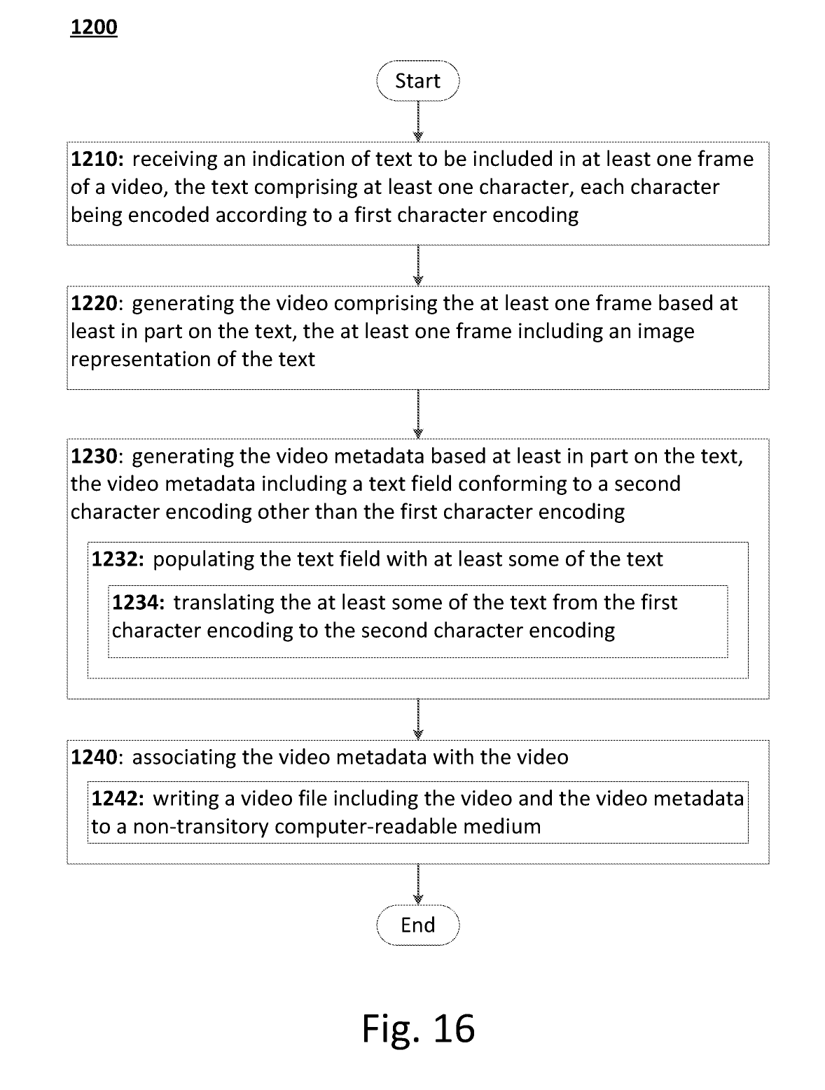

FIG. 16 shows a flowchart of a method 1200 for generating video metadata while generating a video. At step 1210, an indication of the text to be included in at least one frame of the video is received, the text comprising at least one character, each character being encoded according to a first character encoding (e.g. UTF-8). At step 1220, the video is generated based at least in part on the text, the video comprising at least one frame including an image representation of the text. At step 1230, the video metadata is generated based at least in part on the text, the video metadata including a text field conforming to a second character encoding (e.g. UTF-16) other than the first character encoding. Step 1230 comprises step 1232. At step 1232, the text field is populated with at least some of the text. Because the character encoding is different, step 1232 comprises step 1234, namely translating the at least some of the text from the first character encoding to the second character encoding. At step 1240, the video metadata is associated with the video. Step 1240 comprises step 1242. At step 1242, a video file including the video and the video metadata is written to a non-transitory computer-readable medium.

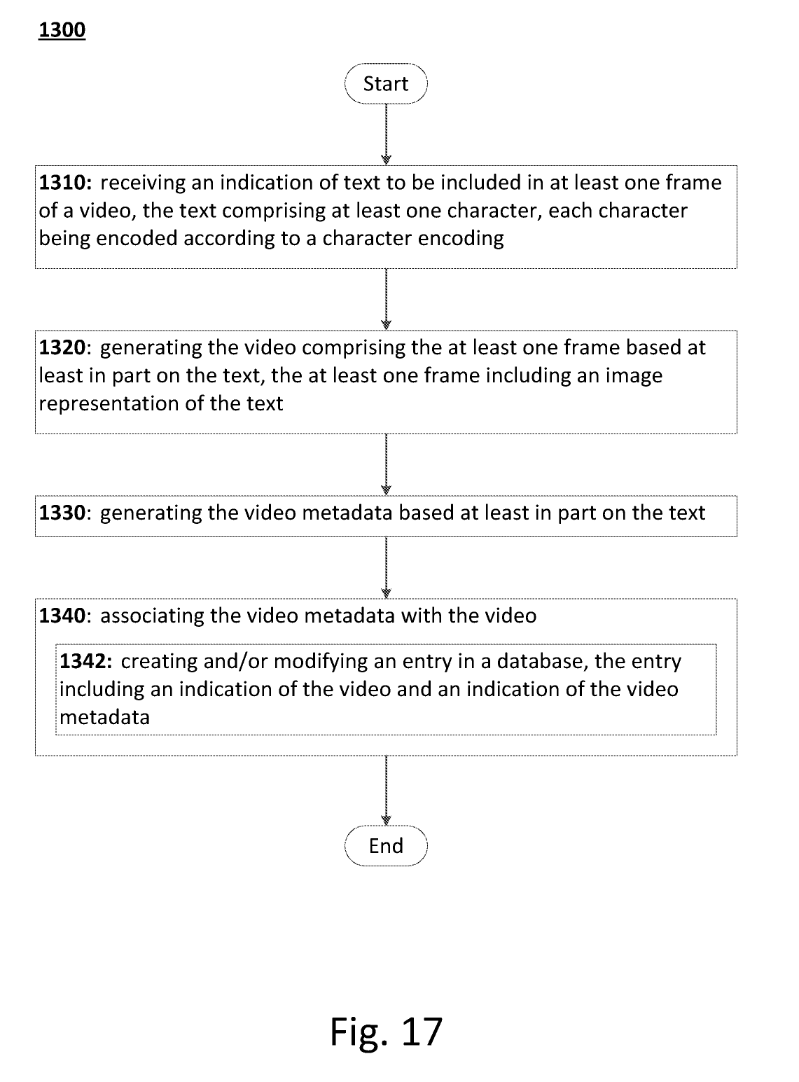

FIG. 17 shows a flowchart of a method 1300 for generating video metadata while generating a video. At step 1310, an indication of text to be included in at least one frame of the video is received. At step 1320, the video comprising the at least one frame is generated based at least in part on the text, the at least one frame including an image representation of the text. At step 1330, the video metadata is generated based at least in part on the text. At step 1340, the video metadata is associated with the video. Step 1340 comprises step 1342. At step 1342, an entry in a database is created and/or modified to include an indication of the video and an indication of the video metadata.

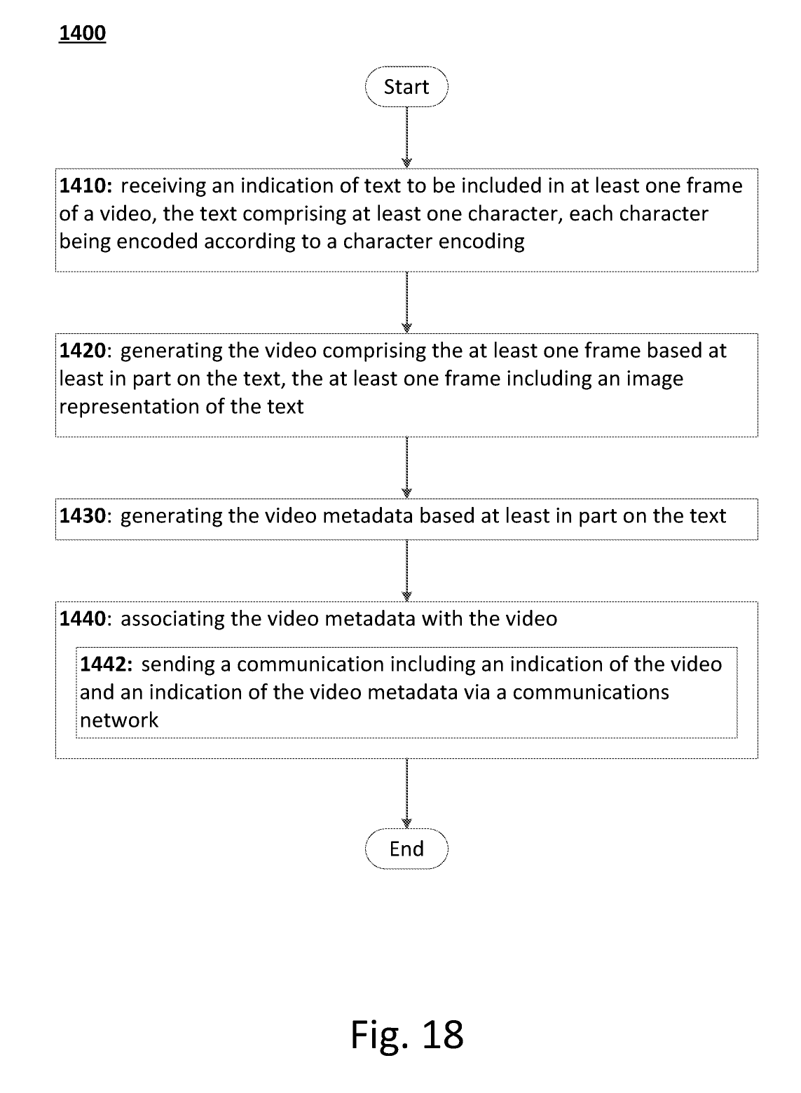

FIG. 18 shows a flowchart of a method 1400 for generating video metadata while generating a video. At step 1410, an indication of text to be included in at least one frame of the video is received. At step 1420, the video comprising the at least one frame is generated based at least in part on the text, the at least one frame including an image representation of the text. At step 1430, the video metadata is generated based at least in part on the text. At step 1440, the video metadata is associated with the video. Step 1440 comprises step 1442. At step 1442, a communication including an indication of the video and an indication of the video metadata is sent via a communications network.

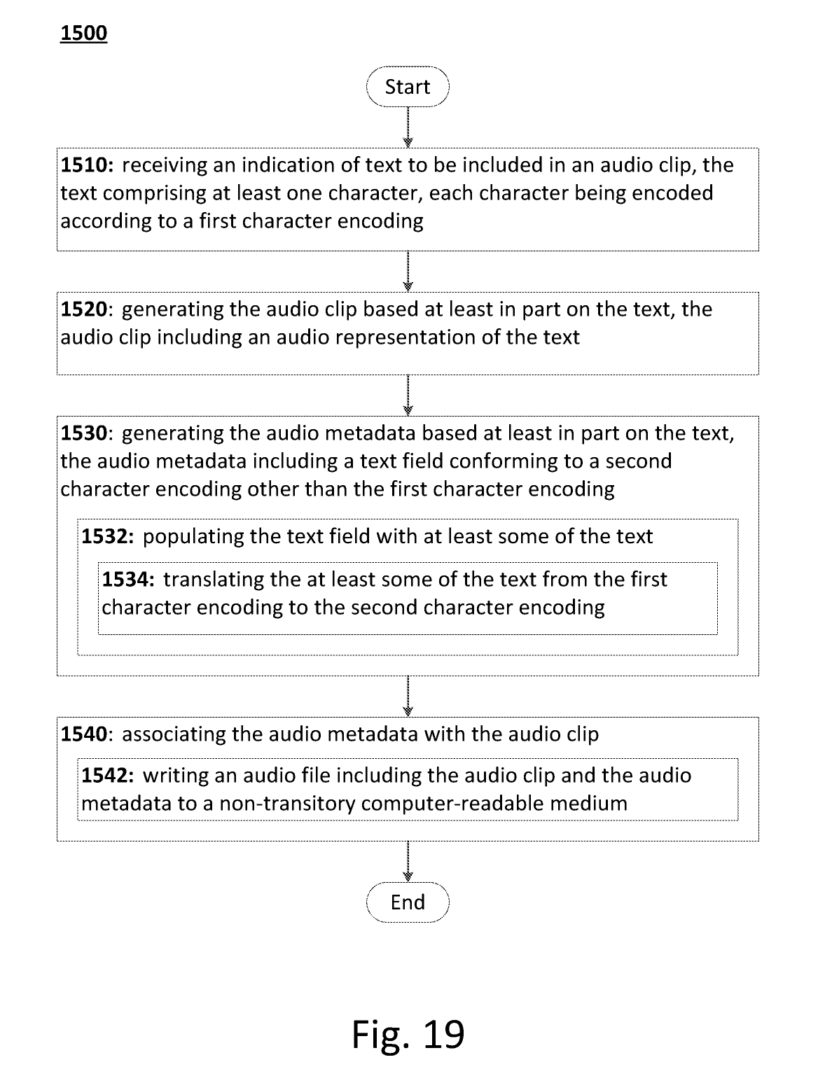

FIG. 19 shows a flowchart of a method 1500 for generating audio metadata while generating an audio clip. At step 1510, an indication of text to be included in the audio clip is received, the text comprising at least one character, each character being encoded according to a first character encoding (e.g. a proprietary, non-standard character encoding). At step 1520, the audio clip is generated based at least in part on the text, the audio clip including an audio representation of the text. For example, a text-to-speech component may be used to generate spoken audio representative of the text. At step 1530, audio metadata is generated based at least in part on the text, the audio metadata including a text field conforming to a second character encoding (e.g. UTF-8) other than the first character encoding. Step 1530 comprises step 1532. At step 1532, the text field is populated with at least some of the text. Because the character encoding is different, step 1532 comprises step 1534, namely translating the at least some of the text from the first character encoding to the second character encoding. At step 1540, the audio metadata is associated with the audio clip. Step 1540 comprises step 1542. At step 1542, an audio file including the audio clip and the audio metadata is written to a non-transitory computer-readable medium.

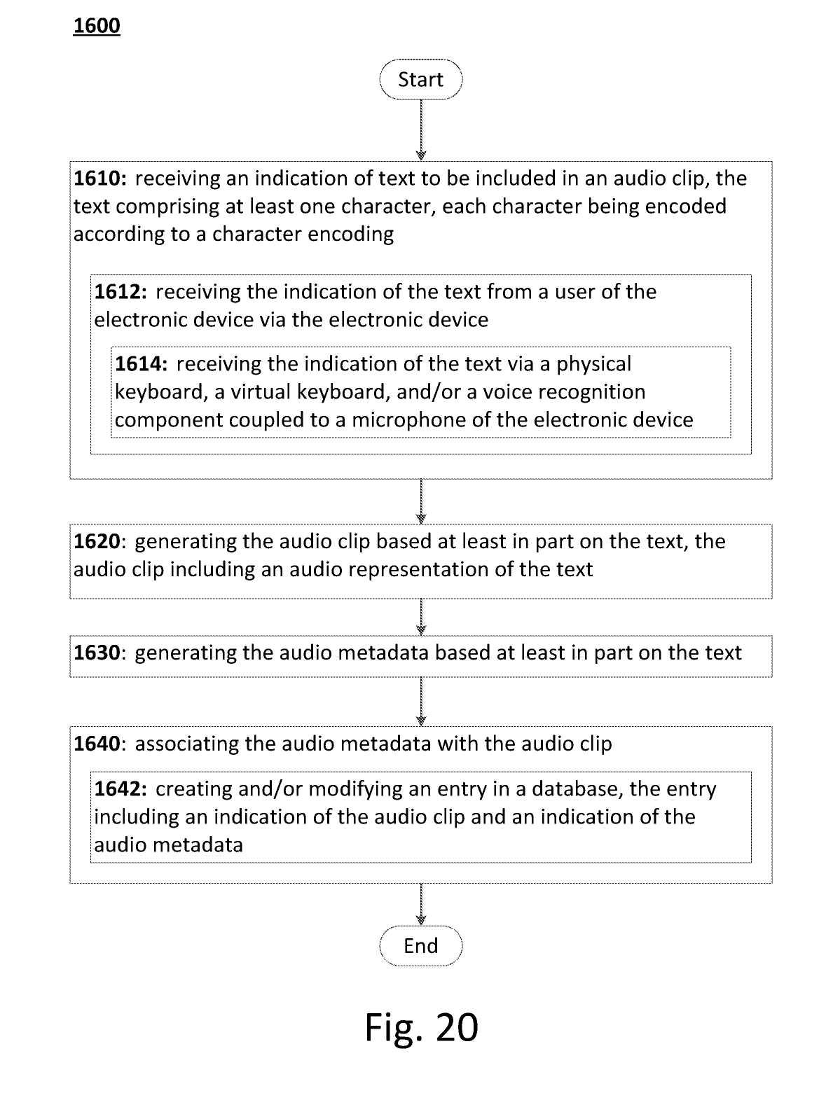

FIG. 20 shows a flowchart of a method 1600 for generating audio metadata while generating an audio clip. At steps 1610/1612/1614, an indication of text to be included in the audio clip is received from a user of the electronic device via at least one of a physical keyboard, a virtual keyboards, and a voice recognition component coupled to a microphone of the electronic device. At step 1620, the audio clip is generated based at least in part on the text, the audio clip including an audio representation of the text. At step 1630, the audio metadata is generated based at least in part on the text. At step 1640, the audio metadata is associated with the audio clip. Step 1640 comprises step 1642. At step 1642, an entry including an indication of the audio clip and an indication of the audio metadata is created and/or modified in a database.

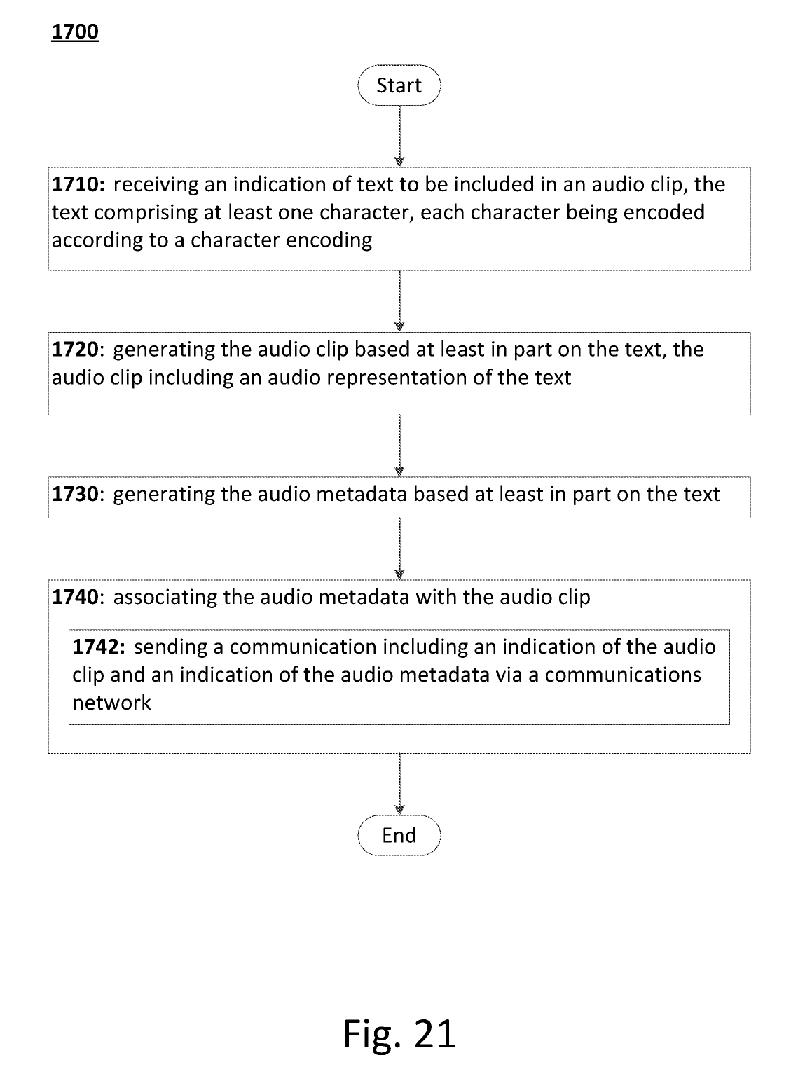

FIG. 21 shows a flowchart of a method 1700 for generating audio metadata while generating an audio clip. At step 1710, an indication of text to be included in the audio clip is received. At step 1720, the audio is generated based at least in part on the text, the audio clip including an audio representation of the text. At step 1730, the audio metadata is generated based at least in part on the text. At step 1740, the audio metadata is associated with the audio clip. Step 1740 comprises step 1742. At step 1742, a communication including an indication of the audio clip and an indication of the audio metadata is sent via a communications network.

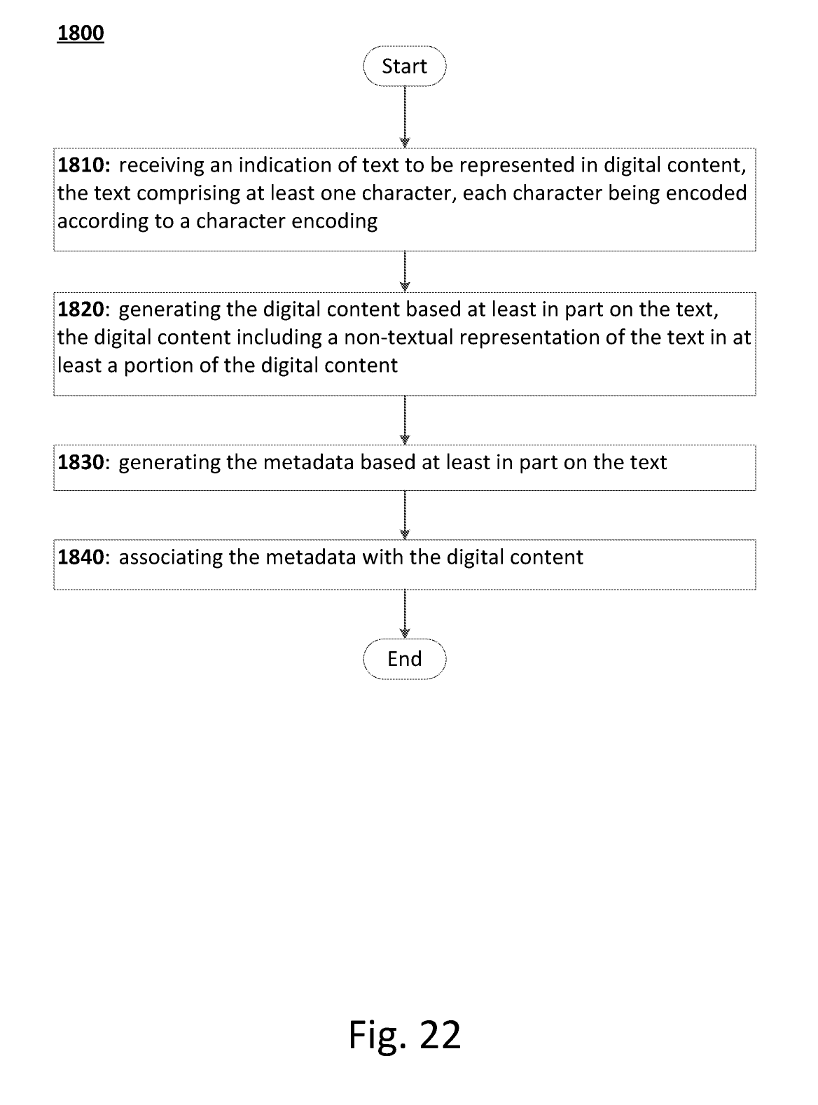

FIG. 22 shows a flowchart of a method 1800 for generating metadata while generating digital content. At step 1810, an indication of text to be represented in digital content is received. At step 1820, the digital content is created based at least in part on the text, the digital content including a non-textual representation of the text in at least a portion of the digital content. At step 1830, the metadata is generated based at least in part on the text. At step 1840, the metadata is associated with the digital content.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of generating image metadata, the method comprising, at an electronic device:
querying an application running at the electronic device, the querying for obtaining text to be included in an image, the text being displayed by the application, the text comprising at least one character, each character having been encoded according to a character encoding;
in response to the querying, receiving the text from the application;
generating the image based at least in part on the text, the image including an image representation of the text;
generating the image metadata based at least in part on the text; and
associating the image metadata with the image.

2. The method of claim 1, wherein:
obtaining the text to be included in the image comprises obtaining text with which to modify an unmodified image; and
generating the image based at least in part on the text comprises generating the image based at least in part on the text and the unmodified image.

3. The method of claim 2, wherein generating the image metadata based at least in part on the text comprises generating the image metadata based at least in part on the text and existing image metadata associated with the unmodified image.

4. The method of claim 3, wherein the unmodified image comprises a screenshot image of a display of the electronic device, and further comprising, before querying the application running at the electronic device:
receiving an instruction to generate the screenshot image from a user of the electronic device; and wherein:
the screenshot image is generated as the unmodified image.

5. The method of claim 3, wherein the unmodified image comprises a screenshot image of a display of a second electronic device in communication with the electronic device via a communications network; and further comprising, before generating the image, receiving the screenshot image from the second digital electronic device via the communications network.

6. (canceled)

7. The method of claim 1, further comprising, before the querying an application running at the device:
receiving an instruction to generate a screenshot image of a display of the electronic device from a user of the electronic device.

8. The method of claim 7, wherein generating the image based at least in part on the text comprises generating the screenshot image as the image.

9. The method of claim 7, wherein generating the image based at least in part on the text is generating the image based at least in part on the text without generating the screenshot image.

10. A method of generating image metadata, the method comprising, at an electronic device:
querying an application running at the electronic device, the querying for obtaining text with which to modify an image, the text being displayed by the application, the text comprising at least one character, each character having been encoded according to a character encoding;
in response to the querying, receiving the text from the application;
modifying the image based at least in part on the text to include an image representation of the text;
generating the image metadata based at least in part on the text; and
associating the image metadata with the image.

11. (canceled)

12. The method of claim 1, wherein the image metadata includes a text field, and generating the image metadata based at least in part on the text includes populating the text field with at least some of the text.

13. The method of claim 12, wherein the character encoding is a first character encoding, the text field conforms to a second character encoding other than the first character encoding, and populating the text field with at least some of the text comprises translating the at least some of the text from the first character encoding to the second character encoding.

14. The method of claim 1, wherein associating the image metadata with the image comprises writing an image file including the image and the image metadata to a non-transitory computer-readable medium.

15. The method of claim 1, wherein associating the image metadata with the image comprises at least one of creating and modifying an entry in a database, the entry including an indication of the image and an indication of the image metadata.

16-28. (canceled)

29. The method of claim 1, wherein receiving the text from the application comprises receiving the text from a user of the electronic device via the electronic device.

30. The method of claim 29, wherein receiving the text from the user of the electronic device comprises receiving the text via at least one of a physical keyboard of the electronic device, a virtual keyboard of the electronic device, and a voice recognition component coupled to a microphone of the electronic device.

31. The method of claim 1, wherein prior to the receiving the text from the application, the method further comprises querying a second electronic device in communication with the electronic device via at least one of a direct link and a communications network.

32. A method of generating metadata, the method comprising, at an electronic device:
querying an application running at the electronic device, the querying for obtaining text to be represented in digital content, the text being displayed by the application, the text comprising at least one character, each character having been encoded according to a character encoding;
in response to the querying, receiving the text from the application;
generating the digital content based at least in part on the text, the digital content including a non-textual representation of the text in at least a portion of the digital content;
generating the metadata based at least in part on the text; and
associating the metadata with the digital content.

34-44. (canceled)
